(19) United States
(12) Patent Application Publication
(10) Pub. No.: US 2026/0266321 A1
(43) Pub. Date: Sep. 10, 2026

(54) SNAP-LOCK STRUCTURAL CONSTRUCTION PLATFORM

(71) Applicant: ENGINO-NET LIMITED, Limassol (CY)

(72) Inventor: Costas Sisamos, Limassol (CY)

(21) Appl. No.: 19/435,956

(22) Filed: Dec. 30, 2025

Related U.S. Application Data
(63) Continuation-in-part of application No. 29/991,969, filed on Mar. 5, 2025.

(51) Int. Cl. F16B 5/06

(52) U.S. Cl. CPC F16B 5/0664

(57) ABSTRACT

A fastener for a structural system has a body extending along an axis. A pair of cantilever lugs extend radially from the body, defining a first engagement surface perpendicular to the axis. The cantilever lugs are diametrically opposed from one another, and each cantilever lug respectively has a locking boss extending from the first engagement surface. A pair of cantilever arms extend radially outward from the body, are diametrically opposed from one another, and are rotationally offset from the cantilever lugs. Each cantilever arm has a biasing tab extending from a distal end, defining a second engagement surface that is spaced from the first engagement surface by an engagement distance. The pair of cantilever arms are resiliently biased by the biasing tab and cantilever arm to resiliently deflect between a relaxed position and a deflected position to vary the engagement distance.

### REFERENCE TO RELATED APPLICATION

This Application is a Continuation-in-Part of U.S. Design Application Serial Number 29/991,969 filed on Mar. 5, 2025, entitled, “SNAP-LOCK CONSTRUCTION PLUG”, the contents of which is hereby incorporated by reference in its entirety.

### TECHNICAL FIELD

The present invention relates generally to apparatuses and systems for selective fastening of various structural members to one another to form various structural assemblies.

### BACKGROUND

Construction toys have been developed for play, education, and industrial modeling. For example, various construction toy building blocks have been previously disclosed, whereby individual blocks formed of injection molded plastic can be interconnected by stacking one atop another to form various models. Male and female connector portions are generally smooth and are held together with friction to be easily disassembled with little force.

Other construction toys have been developed to provide multi-faceted and multi-angular connectable components. For example, various snap-lock construction toy systems and apparatuses are provided in commonly-owned U.S. Patent No. 8,651,914 and U.S. Patent No. 10,905,966, whereby various members can be manually interconnected with little force to form various toy models for play or learning.

Typical snap-lock construction toys, however, are not suitable for bearing substantial weight, such as the weight of a child or various other heavy objects. As such, the conventional snap-lock construction toys are generally limited to models or light duty applications that do not experience significant forces applied thereto that would otherwise cause disassembly of the toy.

Furniture, on the other hand, is defined as objects that are used for a variety of human activities, such as sitting, sleeping, eating, working, and storing items. As such, furniture is typically configured to endure substantial forces without failure due to disassembly.

Heretofore, conventional snap-lock construction toy designs have not been suitable for use as furniture, as they cannot typically endure the substantial forces required for safely supporting the human activities typically applicable in the use of furniture.

### SUMMARY

The present invention provides a fastening system for selective coupling of any number of structural members to one another, whereby structural rigidity and endurance may be achieved. Accordingly, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

The present invention is directed generally toward a fastener for a structural system, such as may be implemented in assembling a piece of furniture or other structure. In accordance with one exemplary aspect of the disclosure, the fastener comprises a body extending along an axis. A pair of cantilever lugs, for example, extend radially outward from the body and define a first engagement surface extending perpendicular to the axis. The pair of cantilever lugs, for example, are approximately 180 degrees opposed from one another when viewed along the axis, and each cantilever lug respectively comprises a locking boss extending from the first engagement surface in a first direction that is approximately parallel to the axis.

A pair of cantilever arms, for example, further extend radially outward from the body, wherein the pair of cantilever arms are approximately 180 degrees opposed from one another when viewed along the axis. The pair of cantilever arms are rotationally offset from the pair of cantilever lugs by a predetermined angle, such as 90 degrees, when viewed along the axis. Each cantilever arm, for example, respectively comprises a biasing tab extending from a distal end of the cantilever arm in a second direction that is approximately opposite the first direction. Each biasing tab defines a second engagement surface, wherein the second engagement surface is spaced from the first engagement surface by an engagement distance when viewed perpendicular to the axis. Accordingly, the pair of cantilever arms are configured to selectively resiliently deflect between a relaxed position and a deflected position, thereby selectively varying the engagement distance.

Accordingly, the fastener may be inserted through a plurality of openings in a respective plurality of structural members. The openings, for example, may comprise a central hole through which the body of the fastener may be positioned, whereby two diametrically-opposed slots extend outwardly from the central hole. Upon alignment and abutment of the openings of respective structural members, the pair of cantilever arms of the fastener are configured to pass through the diametrically-opposed slots, and whereby a 90-degree rotation of the fastener may then couple the plurality of structures together. The biasing tab thus further provides a bias force between the fastener and the structural members, whereby the locking bosses engage the diametrically-opposed slots, thus generally preventing rotation of the fastener with respect to the structures, without additional force to overcome the engagement of the locking bosses with the slots.

In one example, a flange extends radially outward about a periphery of the body, wherein the flange further defines the first engagement surface. The pair of cantilever lugs may thus further extend radially from the flange when viewed along the axis, thus providing a greater contact surface area for engagement with a structural member. The pair of cantilever lugs, for example, are substantially rigid, and the pair of cantilever arms are substantially elastic. As such, the locking boss of each cantilever lug may engage diametrically-opposed slots of the opening, whereby the locking boss locks substantially fixes the rotational position of the fastener with respect to the opening.

In another example, each of the pair of cantilever arms respectively define a tapered arm between the body and the biasing tab. A thickness of the tapered arm, for example, decreases from the body to the biasing tab, thus permitting the deflection between the relaxed position and the deflected position the pair of cantilever arms to provide a snug or tight fit between the structural members and the fastener.

The biasing tab, for example, may extend a tab distance from the tapered arm, and wherein the tab distance decreases at opposing edges of the biasing tab. As such, a bevel is defined at the respective opposing edges of the biasing tab, whereby the bevel generally provides an easing of the biasing the pair of cantilever arms between the relaxed position and the deflected position when rotating the fastener. In one example, the locking boss extends a boss distance from the first engagement surface, and wherein the boss distance is approximately equal to the tab distance, thus further providing a tight fitting between the structural members. The pair of cantilevered arms may be generally rectangular when viewed along the axis, whereby the profile of the pair of cantilevered arms generally match the profile of the opening and slots associated therewith.

In another example, the body, the pair of cantilever lugs, and the pair of cantilever arms are contiguous with one another. For example, the fastener may be of a polymer and be formed by injection molding.

The fastener may further comprise a tool engagement interface, wherein the tool engagement interface may be configured to selectively engage a tool. Upon engagement with the tool engagement interface, the tool may selectively rotate the fastener about the axis based on a rotational force applied to the tool engagement interface by the tool. The tool engagement interface, for example, may comprise a hexagonal slot is defined in the body along the axis, whereby the tool may comprise a hex key or Allen wrench. The tool engagement interface may alternatively comprise one or more of a slot, a cross, a star, a polygonal shape, or a knurled surface, and may extend into the body along the axis, or be formed as an extension of the body.

In accordance with another example of the disclosure, a fastener for a structure is provided, whereby a body of the fastener extends along an axis. In the present example, a flange contiguously extends radially outward from the body, wherein flange defines a first engagement surface extending perpendicular to the axis, and wherein the flange comprises a pair of cantilever lugs extending radially outward from the body. The pair of cantilever lugs are approximately 180 degrees opposed from one another viewed along the axis, wherein each cantilever lug respectively comprises a locking boss extending from the first engagement surface in a first direction that is approximately parallel to the axis.

Further, in the present example, a pair of cantilever arms contiguously extend radially outward from the body, wherein the pair of cantilever arms are approximately 180 degrees opposed from one another when viewed along the axis. The pair of cantilever arms are rotationally offset from the pair of cantilever lugs by approximately 90 degrees when viewed along the axis, wherein each cantilever arm respectively comprises a biasing tab arranged proximate to a radially distal end of the cantilever arm. The biasing tab extends in a second direction that is approximately opposite the first direction, wherein each biasing tab defines a second engagement surface, and wherein each of the pair of cantilever arms is configured to deflect between a relaxed position and a biased position based on a bias force applied in approximately the first direction to the biasing tab. In the relaxed position, the second engagement surface is spaced from the first engagement surface by a first distance, and in the biased position, the second engagement surface is spaced from the first engagement surface by a second distance, wherein the second distance is greater than the first distance.

The pair of cantilever lugs, for example, are substantially rigid, and wherein each of the pair of cantilever arms respectively define a tapered arm between the body and the biasing tab, wherein a thickness of the tapered arm decreases from the body to the biasing tab, and wherein the biasing tab extends a tab distance from the tapered arm. Thus, the tapered arm of each cantilevered arm provides a resiliency thereto. In one example, the tab distance decreases at opposing edges of the biasing tab, thereby defining a bevel at the respective opposing edges of the biasing tab. The locking boss may further extend a boss distance from the first engagement surface, wherein the boss distance is approximately equal to the tab distance.

In the present example, the body may further comprise a tool engagement interface configured to selectively engage a tool and to selectively rotate the fastener about the axis based on a rotational force applied to the tool engagement interface by the tool.

In accordance with yet another example of the disclosure, a fastener is provided for coupling two or more structural members, wherein the fastener comprises a body extending along an axis and a flange contiguously extends radially outward from the body. The flange defines a first engagement surface extending perpendicular to the axis and comprises a pair of cantilever lugs extending radially outward from the body. The pair of cantilever lugs are approximately 180 degrees opposed from one another viewed along the axis, wherein each cantilever lug respectively comprises a locking boss extending from the first engagement surface in a first direction that is approximately parallel to the axis. The locking boss, for example, extends a boss distance from the first engagement surface.

Further, a pair of cantilever arms contiguously extend radially outward from the body, wherein the pair of cantilever arms are approximately 180 degrees opposed from one another when viewed along the axis and are rotationally offset from the pair of cantilever lugs by approximately 90 degrees. Each cantilever arm, for example, respectively comprises a biasing tab arranged proximate to a radially distal end of the cantilever arm, wherein the biasing tab extends in a second direction that is approximately opposite the first direction. Each biasing tab defines a second engagement surface, wherein each of the pair of cantilever arms respectively define a tapered arm between the body and the biasing tab. A thickness of the tapered arm, for example, decreases from the body to the biasing tab, wherein the biasing tab extends from the tapered arm by approximately the boss distance. Each of the pair of cantilever arms, for example, is configured to deflect between a relaxed position and a biased position based on a bias force applied in approximately the first direction to the second engagement surface on the biasing tab, wherein in the relaxed position, the second engagement surface is spaced from the first engagement surface by a first distance, and wherein in the biased position, the second engagement surface is spaced from the first engagement surface by a second distance, wherein the second distance is greater than the first distance.

The above summary is merely intended to give a brief overview of some features of some embodiments of the present disclosure, and other embodiments may comprise additional and/or different features than the ones mentioned above. In particular, this summary is not to be construed to be limiting the scope of the present application. Thus, to the accomplishment of the foregoing and related ends, the disclosure comprises the features hereinafter described and particularly pointed out in the claims. The following description and the annexed drawings set forth in detail certain illustrative embodiments of the disclosure. These embodiments are indicative, however, of a few of the various ways in which the principles of the disclosure may be employed. Other objects, advantages and novel features of the disclosure will become apparent from the following detailed description of the disclosure when considered in conjunction with the drawings.

### BRIEF DESCRIPTION OF THE DRAWINGS

FIG. 1A is an exploded perspective view of a snap-lock structure in accordance with various example aspects of the disclosure.

FIG. 1B is a perspective view of the snap-lock structure of FIG. 1A in an unlocked in accordance with various example aspects of the disclosure.

FIG. 1C is a perspective view of the snap-lock structure of FIGS. 1A and 1B in position in a locked position accordance with various example aspects of the disclosure.

FIG. 2A illustrates a front, top, and side perspective view of a fastener according to one example of the present disclosure.

FIG. 2B illustrates a front, bottom, and side perspective view of a fastener according to the example of FIG. 2A.

FIG. 2C illustrates a top elevation view of the fastener according to the example of FIG. 2A.

FIG. 2D illustrates a bottom elevation view of the fastener according to the example of FIG. 2A.

FIG. 2E illustrates a side elevation view of the fastener according to the example of FIG. 2A.

FIG. 2F illustrates a front elevation view of the fastener according to the example of FIG. 2A.

### DETAILED DESCRIPTION OF THE INVENTION

The present disclosure relates to apparatuses and systems associated with assembly of structural components. The structural components, for example, may have similar aesthetics to various snap-lock construction toys. Accordingly, the present invention will now be described with reference to the drawings, wherein like reference numerals may be used to refer to like elements throughout. It is to be understood that the description of these aspects is merely illustrative and that they should not be interpreted in a limiting sense. In the following description, for purposes of explanation, numerous specific details are set forth in order to provide a thorough understanding of the present invention. It will be evident to one skilled in the art, however, that the present invention may be practiced without these specific details. Further, the scope of the invention is not intended to be limited by the embodiments or examples described hereinafter with reference to the accompanying drawings, but is intended to be only limited by the appended claims and equivalents thereof.

It is also noted that the drawings are provided to give an illustration of some aspects of embodiments of the present disclosure and therefore are to be regarded as schematic only. In particular, the elements shown in the drawings are not necessarily to scale with each other, and the placement of various elements in the drawings is chosen to provide a clear understanding of the respective embodiment and is not to be construed as necessarily being a representation of the actual relative locations of the various components in implementations according to an embodiment of the invention. Furthermore, the features of the various embodiments and examples described herein may be combined with each other unless specifically noted otherwise.

It is also to be understood that in the following description, any direct connection or coupling between functional blocks, devices, components, elements or other physical or functional units shown in the drawings or described herein could also be implemented by an indirect connection or coupling. Furthermore, it is to be appreciated that functional blocks or units shown in the drawings may be implemented as separate features or components in one embodiment, and may also or alternatively be fully or partially implemented in a common feature or component in another embodiment.

A snap-lock apparatus of the present disclosure may utilize reusable snap-lock components and/or friction-fit components configured to enable a user to construct and/or assemble various structural articles such as shelving, furniture, or other structural assemblies of various shapes and configurations. The present disclosure further provides a platform for assembling and creating a multitude of structural assemblies, whereby the structural assemblies may be easily assembled, disassembled, and modified. The structure may be any arrangement or organization of interrelated elements in a material object or system.

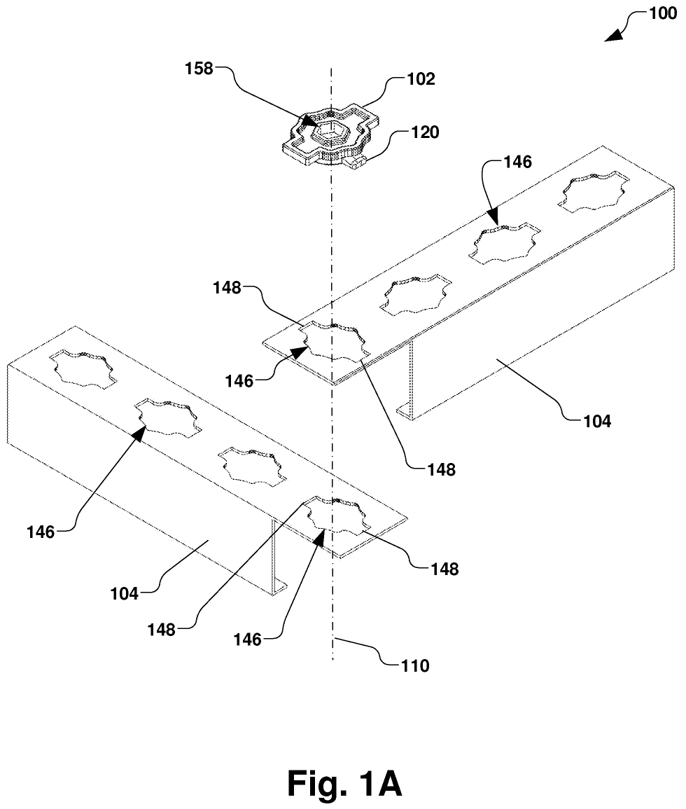

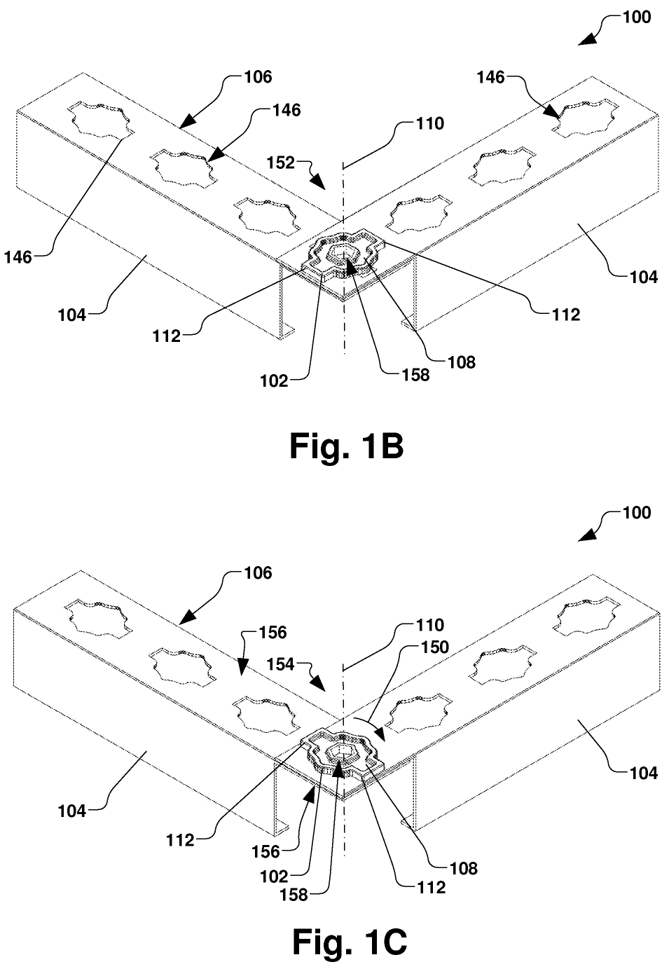

As illustrated in FIGS. 1A-1C, a structure assembly system 100 is provided, whereby a fastener 102 (also called a connection member or a plug), is provided for operably coupling a plurality of structural members 104 together. The fastener 102, for example, is configured to provide structural integrity to a structure 106 illustrated in FIGS. 1B-1C, such that the structure has the ability to withstand an intended loading without failing due to fracture, deformation, or fatigue. In one example, the structure 106 may comprise or be a component of various types of furniture, such as a chair, desk, shelf, or other furniture having structural integrity. In other examples, the structure 106 can comprise any assembly comprising a beam, strip, or any member of any shape or material that is configured to accept the fastener, as will be appreciated infra. For example, the structure 106 can comprise a toy or makerspace structure that may be useful in a learning environment.

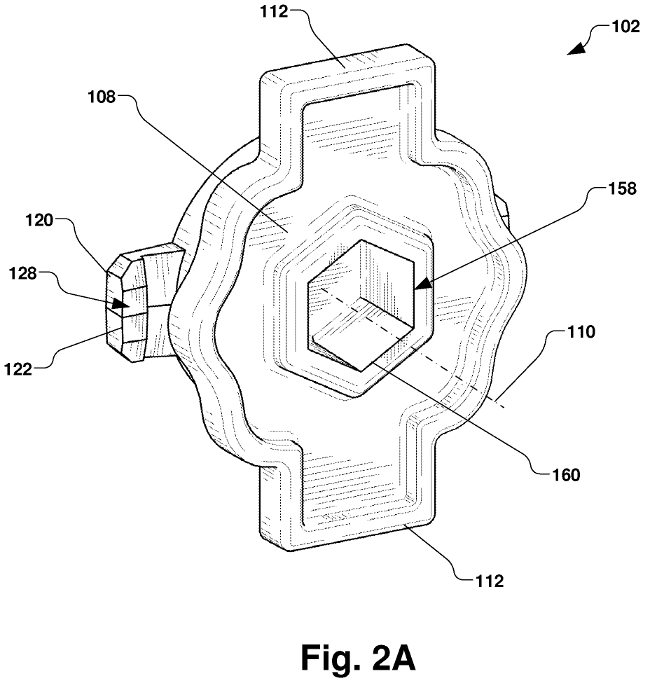

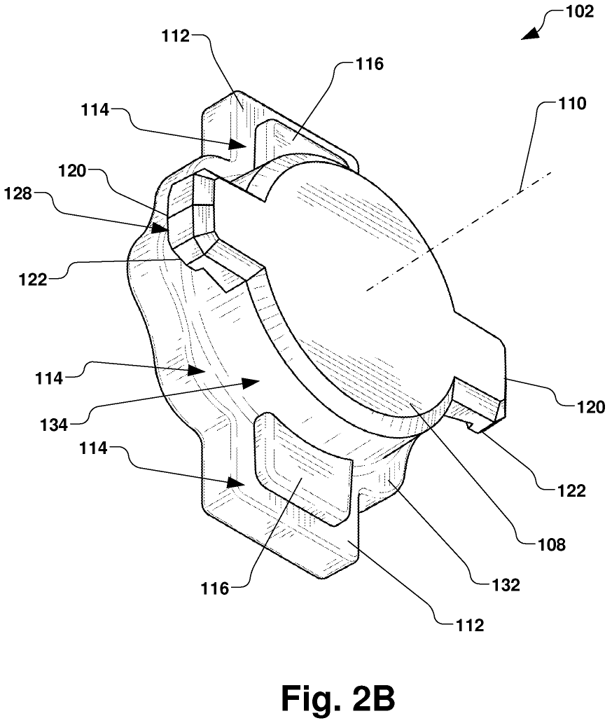

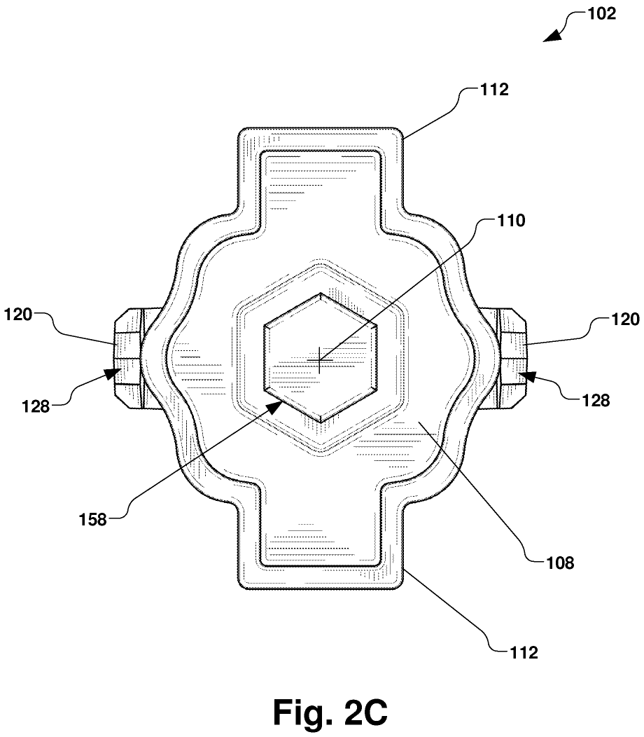

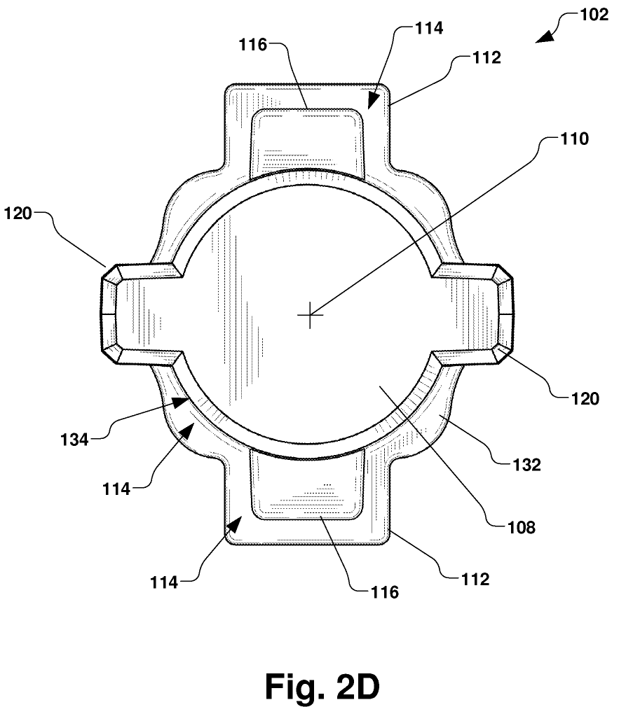

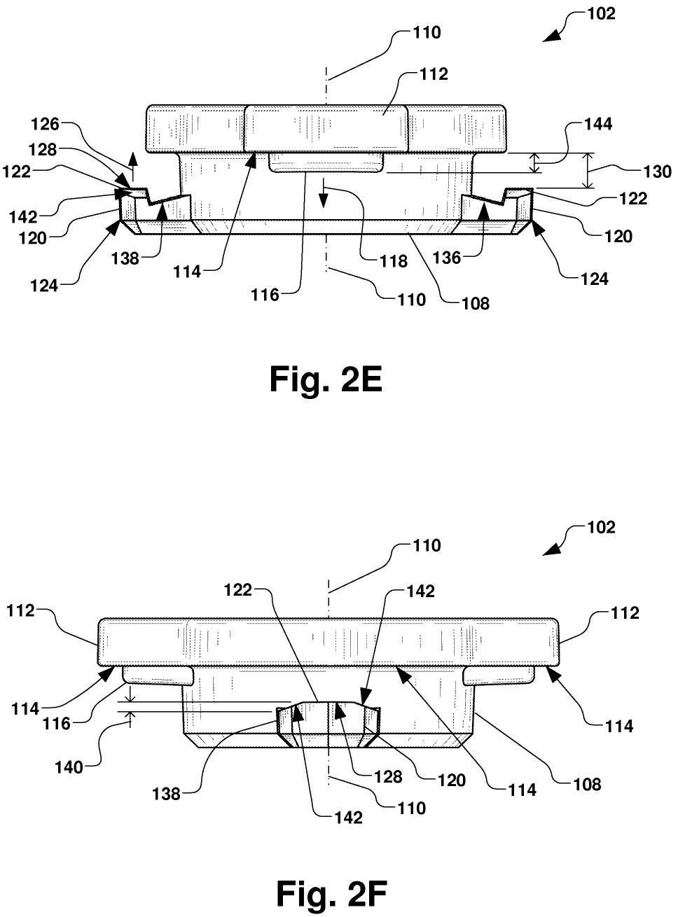

Referring generally to FIGS. 2A-2F, the fastener 102, for example, comprises a body 108 (e.g., a cylindrical shaft) extending along an axis 110. As illustrated in FIG. 2B, for example, the fastener 102 comprises a pair of cantilever lugs 112 extending radially outward from the body 108, whereby the pair of cantilever lugs generally define a first engagement surface 114 extending perpendicular to the axis 110 the fastener. In the present example, the pair of cantilever lugs 112 are approximately 180 degrees opposed from one another when viewed along the axis 110, as shown in FIGS. 2C-2D. Each cantilever lug 112, for example, further respectively comprises a locking boss 116 extending outwardly from the first engagement surface 114 in a first direction 118 (e.g., illustrated as arrow in FIG. 2E) that is approximately parallel to the axis 110.

Further, a pair of cantilever arms 120 extend radially outward from the body 108, wherein the pair of cantilever arms are approximately 180 degrees opposed from one another when viewed along the axis 110, as shown in FIGS. 2C-2D. It is noted that while the pair of cantilever lugs 112 and the pair of cantilever arms 120 are respectively described and illustrated as opposing one another by approximately 180 degrees, other examples, such as any number of cantilever lugs and cantilever arms, and any spacing or arrangement(s) therebetween are contemplated.

The pair of cantilever arms 120, for example, are rotationally offset from the pair of cantilever lugs 112 by a predetermined angle when viewed along the axis 110. In the present example, the pair of cantilever arms 120 and the pair of cantilever lugs 112 are rotationally offset from one another by approximately 90 degrees. However, it is noted that other configurations are also contemplated, such the predetermined angle being approximately 45 degrees, 30 degrees, or other angle(s).

As illustrated in FIG. 2E, each cantilever arm 120, for example, respectively comprises a biasing tab 122 extending from a distal end 124 of the cantilever arm in a second direction 126 (e.g., illustrated as arrow), whereby the second direction is approximately opposite the first direction 118. Each biasing tab 122, for example, defines a second engagement surface 128, wherein the second engagement surface is spaced from the first engagement surface 114 by an engagement distance 130 when viewed perpendicular to the axis 110, as illustrated in FIG. 2E. The pair of cantilever arms 120, for example, are configured to selectively resiliently deflect between a relaxed position and a deflected position based on a force applied to the pair of cantilever arms (e.g., between the first engagement surface 114 and the second engagement surface 128), thereby selectively varying the engagement distance 130. The pair of cantilever lugs 112, for example, may be substantially rigid, while the pair of cantilever arms 120 are substantially elastic (e.g., as in cantilever spring).

Accordingly, the fastener 102 is configured to selectively couple any number of structural members 104 of FIGS. 1A-1C between the first engagement surface 114 and the second engagement surface 128. The structural members 104, for example, can be similar or dissimilar, and can each comprise a beam, and angled member, a plate, a strip, or a member of any shape or size. Further, the structural members 104, for example, can be formed of any material providing substantial rigidity, such as metal, wood, plastic, or other substantially sturdy material. Further, the fastener 102 may be a unitary component, whereby the body 108, the pair of cantilever lugs 112, and the pair of cantilever arms 120 are contiguous with one another. The fastener 102, for example, may be comprised of a polymer and be formed by injection molding or other known process. In other examples, the fastener may be comprised of plastic, wood, or metal. Preferably, the fastener 102 has a flexibility to allow for the pair of cantilever arms 120 to provide a friction fit while permitting flexibility for installation and removal.

The fastener 102, as illustrated in FIG. 2B for example, may further comprise a flange 132 extending radially outward about a periphery 134 of the body 108, wherein the pair of cantilever lugs 112 further extend radially from the flange when viewed along the axis 110. Accordingly, the flange 132 further defines the first engagement surface 114.

In accordance with one example, each of the pair of cantilever arms 120 respectively define a tapered arm 136 between the body 108 and the biasing tab 122, whereby a taper 138 (e.g., a thickness when viewed perpendicular to the axis 110) of the tapered arm decreases from the body to the biasing tab, as illustrated in FIG. 2E. The taper 138, for example, generally permit the deflection between the relaxed position and the deflected position the pair of cantilever arms 120 (e.g., the variation of the engagement distance) to provide a snug or tight fit between the structural members 104 and the fastener 102 of FIGS. 1A-1C, as will be discussed further infra.

The biasing tab 122, for example, may extend a tab distance 140 from the tapered arm 136, and wherein the tab distance decreases at opposing edges of the biasing tab, thereby defining a bevel 142 at the respective opposing edges of the biasing tab. The bevel 142, for example, generally provides an easing of the biasing the pair of cantilever arms 120 between the relaxed position and the deflected position when rotating the fastener 102.

The locking boss 116 shown in FIG. 2E, for example, extends a boss distance 144 from the first engagement surface 114. In one example, the boss distance 144 is approximately equal to the tab distance 140 of FIG. 2F, thus further providing a tight fitting between the structural members 104 of FIGS. 1A-1C.

The fastener 102 and pair of cantilever arms 120 of FIGS. 2A-2F, for example, may be configured to selectively engage and pass through one or more openings 146 (e.g., holes) in the structural members 104 of FIGS. 1A-1C, whereby the one or more openings having one or more slots 148 (e.g., radially extending slots) defined therein. In accordance with one example, selective coupling of the structural members 104 is achieved by rotating the body 108 (e.g., illustrated by rotation 150 in FIG. 1C) with respect to the structural members approximately 90 degrees.

Accordingly, the fastener 102 is configured to be selectively positioned within the openings 146 and to selectively couple the structural members 104 between the first engagement surface 114 and the second engagement surface 128 via a selective interface between the locking boss 116 and the slot 148 of one structural member and a selective interface between the one or more biasing tabs 122 and another slot of another structural member.

For example, the fastener 102 may be axially aligned with each respective opening 146 in the structural members 104 such that fastener is partially passed through the respective openings. Each respective biasing tab is configured to selectively pass through the respective slots 148 in the respective structural members in an unlocked position 152 of FIG. 1B, whereby the fastener 102 may be subsequently rotated (e.g., 90 degrees about the axis 110) with respect to the respective openings 146 to a locked position 154 of FIG. 1C. As such, each biasing tab 122 is rotated out of the respective slots 148 of FIG. 1B, and each locking boss 116 is respectively rotated into the respective slots of FIG. 1C, thus generally fixing the fastener with respect to the structural members via the engagement between the respective locking boss and slot. Each biasing tab 122 thus biases the fastener 102 between opposing surfaces 156 of the respective structural members 104 and provides predetermined locking force to maintain the one or more locking boss 116 in the respective slots of the structural member.

The pair of cantilevered arms 120, for example, may be generally rectangular when viewed along the axis 110, whereby the profile of the pair of cantilevered arms generally match the profile of the openings 146 and slots 148 associated with the structural members 104.

The fastener 102 may further comprise a tool engagement interface 158 illustrated in FIG. 2A, wherein the tool engagement interface may be configured to selectively engage a too (not shown) for the selective rotation 150 of the fastener shown in FIG. 1C. Upon engagement with the tool engagement interface 158, the tool may selectively rotate the fastener 102 about the axis 110 based on a rotational force applied to the tool engagement interface by the tool. The tool engagement interface 158 illustrated in FIG. 2A, for example, may comprise a hexagonal slot 160 defined in the body 108 along the axis 110, whereby the tool may comprise a hex key or Allen wrench. In other examples, while not shown, the tool engagement interface 158 may alternatively comprise one or more of a slot, a cross, a star, a polygonal shape, or a knurled surface, and may extend into the body 108 along the axis 110, or be formed as an extension of the body, and all such examples are contemplated as falling within the scope of the present disclosure. As such, a tool such as a screwdriver, wrench, or other tool may be utilized to enable the selective rotation of the fastener 102 with respect to the structural members 104.

In one example, the tool engagement interface 158 extends inwardly into the body 108, as discussed above. Alternatively, the tool engagement interface 158 may extend outwardly from the body 108. In yet another alternative example, the body 108 can define one or more grip features (e.g., a knurled surface, a wavy surface, or one or more grip extensions) configured to be selectively gripped by a user to enable the selective rotation of the fastener 102.

Thus, the present disclosure contemplates the rotation 150 of the fastener 102 with respect to the structural members 104 to selectively squeeze the structural members toward one another.

In accordance with another example, a structural construction apparatus is provided. The structural construction apparatus comprises a fastener, such as described above. A locking force (e.g., a predetermined rotational force) is defined by a configuration of the respective locking boss 116 and the biasing tab 122, whereby the fastener 102 is fixed in position up to the locking force. When a rotational force is applied to the fastener 102 beyond the locking force, the fastener is configured to rotate the respective locking boss 116 out of the one respective slots 148 for further selective removal of the fastener from the openings 146 for disassembly of the structural construction apparatus.

It is noted that various features of the present disclosure, while differing in some designs and function, may be configured to be have similar aesthetics to various other construction toy systems and apparatuses, such as, for example, those provided in commonly-owned U.S. Utility Patent Nos. 8,651,914, 10,163,365, U.S. Design Patent Nos. D612,435, D812,151, D825,678, U.S. Patent Publication Numbers 2017/0209802 and 2017/0209801, and U.S. Patent Application Serial Nos. 29/721,603, 29/721,621, 29/721,602, 29/721,600, 29/721,720, 29/721,641, and 29/721,605, the contents of which are incorporated by reference herein, in their entireties.

Although the invention has been shown and described with respect to a certain embodiment or embodiments, it should be noted that the above-described embodiments serve only as examples for implementations of some embodiments of the present invention, and the application of the present invention is not restricted to these embodiments. In particular regard to the various functions performed by the above described components (assemblies, devices, circuits, etc.), the terms (including a reference to a “means”) used to describe such components are intended to correspond, unless otherwise indicated, to any component which performs the specified function of the described component ( i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application. Accordingly, the present invention is not to be limited to the above-described embodiments, but is intended to be limited only by the appended claims and equivalents thereof.

What is claimed is:

1. A fastener for a structural system, the fastener comprising:
a body extending along an axis;
a pair of cantilever lugs extending radially outward from the body and defining a first engagement surface extending perpendicular to the axis, wherein the pair of cantilever lugs are approximately 180 degrees opposed from one another when viewed along the axis, and wherein each cantilever lug respectively comprises a locking boss extending from the first engagement surface in a first direction that is approximately parallel to the axis; and
a pair of cantilever arms extending radially outward from the body, wherein the pair of cantilever arms are approximately 180 degrees opposed from one another when viewed along the axis, wherein the pair of cantilever arms are rotationally offset from the pair of cantilever lugs by a predetermined angle when viewed along the axis, and wherein each cantilever arm respectively comprises a biasing tab extending from a distal end of the cantilever arm in a second direction that is approximately opposite the first direction, wherein each biasing tab defines a second engagement surface, wherein the second engagement surface is spaced from the first engagement surface by an engagement distance when viewed perpendicular to the axis, and wherein the pair of cantilever arms are configured to selectively resiliently deflect between a relaxed position and a deflected position, thereby selectively varying the engagement distance.

2. The fastener of claim 1, further comprising a flange extending radially outward about a periphery of the body, wherein the pair of cantilever lugs further extend radially from the flange when viewed along the axis, and wherein the flange further defines the first engagement surface.

3. The fastener of claim 1, wherein the body comprises a cylindrical shaft.

4. The fastener of claim 1, wherein the pair of cantilever lugs are substantially rigid, and wherein the pair of cantilever arms are substantially elastic.

5. The fastener of claim 1, wherein each of the pair of cantilever arms respectively define a tapered arm between the body and the biasing tab, wherein a thickness of the tapered arm decreases from the body to the biasing tab.

6. The fastener of claim 5, wherein the biasing tab extends a tab distance from the tapered arm, and wherein the tab distance decreases at opposing edges of the biasing tab, thereby defining a bevel at the respective opposing edges of the biasing tab.

7. The fastener of claim 6, wherein the locking boss extends a boss distance from the first engagement surface, and wherein the boss distance is approximately equal to the tab distance.

8. The fastener of claim 1, wherein the pair of cantilevered arms are generally rectangular when viewed along the axis.

9. The fastener of claim 1, wherein the body, the pair of cantilever lugs, and the pair of cantilever arms are contiguous with one another and are comprised of a polymer.

10. The fastener of claim 1, wherein the predetermined angle is approximately 90 degrees.

11. The fastener of claim 1, further comprising a tool engagement interface configured to selectively engage a tool and to selectively rotate the fastener about the axis based on a rotational force applied to the tool engagement interface by the tool.

12. The fastener of claim 11, wherein the tool engagement interface comprises a hexagonal slot is defined in the body along the axis.

13. The fastener of claim 11, wherein the tool engagement interface comprises one or more of a slot, a cross, a star, a polygonal shape, or a knurled surface.

14. The fastener of claim 11, wherein the tool engagement interface extends into the body along the axis.

15. A fastener for a structure, the fastener comprising:
a body extending along an axis;
a flange contiguously extending radially outward from the body, wherein flange defines a first engagement surface extending perpendicular to the axis, and wherein the flange comprises a pair of cantilever lugs extending radially outward from the body, wherein the pair of cantilever lugs are approximately 180 degrees opposed from one another viewed along the axis, and wherein each cantilever lug respectively comprises a locking boss extending from the first engagement surface in a first direction that is approximately parallel to the axis; and
a pair of cantilever arms contiguously extending radially outward from the body, wherein the pair of cantilever arms are approximately 180 degrees opposed from one another when viewed along the axis, wherein the pair of cantilever arms are rotationally offset from the pair of cantilever lugs by approximately 90 degrees when viewed along the axis, and wherein each cantilever arm respectively comprises a biasing tab arranged proximate to a radially distal end of the cantilever arm, wherein the biasing tab extends in a second direction that is approximately opposite the first direction, wherein each biasing tab defines a second engagement surface, and wherein each of the pair of cantilever arms is configured to deflect between a relaxed position and a biased position based on a bias force applied in approximately the first direction to the biasing tab, wherein in the relaxed position, the second engagement surface is spaced from the first engagement surface by a first distance, and wherein in the biased position, the second engagement surface is spaced from the first engagement surface by a second distance, wherein the second distance is greater than the first distance.

16. The fastener of claim 15, wherein the pair of cantilever lugs are substantially rigid, and wherein each of the pair of cantilever arms respectively define a tapered arm between the body and the biasing tab, wherein a thickness of the tapered arm decreases from the body to the biasing tab, and wherein the biasing tab extends a tab distance from the tapered arm.

17. The fastener of claim 16, wherein the tab distance decreases at opposing edges of the biasing tab, thereby defining a bevel at the respective opposing edges of the biasing tab.

18. The fastener of claim 16, wherein the locking boss extends a boss distance from the first engagement surface, and wherein the boss distance is approximately equal to the tab distance.

19. The fastener of claim 15, wherein the body further comprises a tool engagement interface configured to selectively engage a tool and to selectively rotate the fastener about the axis based on a rotational force applied to the tool engagement interface by the tool.

20. A fastener for coupling two structural members, the fastener comprising:
a body extending along an axis;
a flange contiguously extending radially outward from the body, wherein flange defines a first engagement surface extending perpendicular to the axis, and wherein the flange comprises a pair of cantilever lugs extending radially outward from the body, wherein the pair of cantilever lugs are approximately 180 degrees opposed from one another viewed along the axis, and wherein each cantilever lug respectively comprises a locking boss extending from the first engagement surface in a first direction that is approximately parallel to the axis, wherein the locking boss extends a boss distance from the first engagement surface; and
a pair of cantilever arms contiguously extending radially outward from the body, wherein the pair of cantilever arms are approximately 180 degrees opposed from one another when viewed along the axis, wherein the pair of cantilever arms are rotationally offset from the pair of cantilever lugs by approximately 90 degrees when viewed along the axis, and wherein each cantilever arm respectively comprises a biasing tab arranged proximate to a radially distal end of the cantilever arm, wherein the biasing tab extends in a second direction that is approximately opposite the first direction, wherein each biasing tab defines a second engagement surface, wherein each of the pair of cantilever arms respectively define a tapered arm between the body and the biasing tab, and wherein a thickness of the tapered arm decreases from the body to the biasing tab, and wherein the biasing tab extends from the tapered arm by approximately the boss distance, wherein each of the pair of cantilever arms is configured to deflect between a relaxed position and a biased position based on a bias force applied in approximately the first direction to the biasing tab, wherein in the relaxed position, the second engagement surface is spaced from the first engagement surface by a first distance, and wherein in the biased position, the second engagement surface is spaced from the first engagement surface by a second distance, wherein the second distance is greater than the first distance.
